(19) United States
(12) Patent Application Publication
(10) Pub. No.: US 2010/0018809 A1
(43) Pub. Date: Jan. 28, 2010

(54) Elevator arrangement, method and safety structure

(75) Inventors: Mark Peacock, Riihimaki (FI); Zhizhong Yan, Espoo (FI)

Correspondence Address: BIRCH STEWART KOLASCH & BIRCH, PO BOX 747, FALLS CHURCH, VA, 22040-0747, US

(73) Assignee: KONE CORPORATION, Helsinki (FI)

(21) Appl. No.: 12/289,343

(22) Filed: Oct. 24, 2008

(30) Foreign Application Priority Data
Jul. 24, 2008 (FI) FI20080444
Oct. 9, 2008 (FI) FI20080566

(51) Int. Cl. B66B 5/00

(52) U.S. Cl. 187/251; 187/406; 187/351; 187/343

(57) ABSTRACT

An elevator arrangement, comprising at least one elevator shaft, a working platform, elevator car or equivalent arranged to move in the elevator shaft, a power source for moving the said working platform or equivalent e.g. by means of ropes, chains, belts or equivalent, characterized in that the vertical range of movement of the said working platform or equivalent in the elevator shaft has been temporarily delimited in such manner that its movement can only take place in a section of the elevator shaft, by means of a structure (1), preferably a beam, which is mounted in the elevator shaft in the path of the said working platform, elevator car or equivalent, said structure (1) being fitted in the elevator shaft below the said working platform, elevator car or equivalent at a distance from the bottom of the elevator shaft.

### FIELD OF THE INVENTION

The present invention relates to an elevator arrangement as defined in the preamble of claim 1, to a method as defined in the preamble of claim 13 and to a safety structure as defined in the preamble of claim 19.

### BACKGROUND OF THE INVENTION

During the construction of elevators, installation work is carried out in, an elevator shaft from a platform or equivalent provided in the elevator shaft. The installation work includes the mounting of guide rails in the elevator shaft. The platform is often movable so as to allow the working height to be changed. In many cases this is implemented utilizing so-called Tirak hoists, but other types of hoist can also be used. The hoists can may move the platform by means of a chain (or equivalent, such as e.g. a rope) with a 1:1 hoisting ratio, for example in an arrangement where the hoist is fixed to the platform and exerts a pull on a chain whose one end is fastened to a beam placed in the elevator shaft above the platform. Alternatively, the platform can be pulled with a 2:1 hoisting ratio e.g. by using an arrangement where the chain of a hoist attached to the elevator car passes around a diverting pulley mounted on a hoisting beam fastened to the upper part of the elevator shaft and then returns back down to the hoist on the elevator car. In this arrangement, shortening the chain loop around the diverting pulley by means of the hoist causes the platform to rise.

In the case of so-called jump elevators, the lower part of the elevator shaft has been taken into use before the building has been finished. In such cases, construction of the upper part of the elevator shaft and installation of elevator components in the shaft can be carried on while an elevator movable in the lower part of the elevator shaft is already serving passengers on the lower floors of the building. Especially when working in an elevator shaft in a tall building, the installer is susceptible to hazards. For example, even a small tool falling down from on high is dangerous to people working below. A corresponding danger results if elevator shafts located side by side are being constructed simultaneously and objects are accidentally dropped so that they can pass from one shaft into another. In such a situation, it is not sufficient that only that shaft from whose upper part the object falls be void of people in the lower part. Thus it is desirable that the lower part of the adjacent shaft be void as well. Particularly perilous hazards have aAlso, resulted from the circumstance that it has been possible to drive a platform with a hoist having a limited hoisting height to a level too far down in the elevator shaft has led to particularly perilous hazards, because, below the lower limit of the hoisting range of the hoist, the shaft is substantially empty and extends a long way downward, even down to the lowest level of the shaft or, in the case of a jump elevator, to the level of the machine room. This hazard is most commonly encountered in the installation of high-rise elevators when structures are being installed in the upper part of the elevator shaft and when the height of the elevator shaft is greater than the maximum hoisting distance of the hoist. In an arrangement like this, the user might drive the working platform too far down in the elevator shaft. A hazardous situation arises e.g. if the chain of a Tirak hoist runs out of length before the movement has been completed, in which case the chain may fall down into the elevator shaft and/or the platform unexpectedly loses support. The platform may thus start falling down, causing a particularly serious hazard situation. The platform may also start falling down due to other causes, e.g. if the hoisting ropes break or the hoist breaks down.

### OBJECT OF THE INVENTION

The object of the present invention is to overcome some of the above-mentioned drawbacks of previously known prior-art solutions, among other things. A specific object of the invention is to produce an elevator arrangement, a method and a safety structure that will make it possible to improve elevator safety during construction time. A further object of the invention is to achieve one or more of the following advantages:
The invention makes it possible to ensure in a simple manner that all essential parts of the elevator shaft/shafts are void of people.
The invention makes it possible to ensure that the maximal distance through which an object falls before hitting a person working in the shaft will not exceed an allowed maximum limit or become very large.
The A working platform, elevator car or equivalent can not be driven too far down in the elevator shaft.
The structure of the invention can be easily moved.
The structure of the invention can not fall down itself.
A safer method and a safer arrangement are achieved.
A simple and safe multi-function structure is achieved.
The invention makes it possible to stop a working platform that for some reason has started to fall.
The working platform can be prevented from advancing too far into the finished part of the elevator shaft below it.
The range of movement of a working platform or equivalent in an elevator shaft under construction or in an elevator shaft section under construction can be delimited in such manner that the elevator shaft or shaft section under construction comprises a portion where the working platform or equivalent can is allowed to move and a portion where the working platform or equivalent can is not allowed to not move,

### BRIEF DESCRIPTION OF THE INVENTION

The arrangement of the invention is characterized by what is disclosed in the characterizing part of claim 1. The method of the invention is characterized by what is disclosed in the characterizing part of claim 13. The safety structure of the invention is characterized by what is disclosed in the characterizing part of claim 19. Other embodiments of the invention are characterized by what is disclosed in the other claims. Inventive embodiments are also presented in the description part and drawings of the present application. The inventive content disclosed in the application can also be defined in other ways than is done in the claims below. The inventive content may also consist of several separate inventions, especially if the invention is considered in the light of explicit or implicit sub-tasks or with respect to advantages or sets of advantages achieved. In this case, some of the attributes contained in the claims below may be superfluous from the point of view of separate inventive concepts. The features of different embodiments of the invention can be applied in connection with other embodiments within the scope of the basic inventive concept

According to the invention, the elevator arrangement comprises at least one elevator shaft, a working platform or equivalent arranged to move in the elevator shaft, a power source for moving the aforesaid working platform or equivalent e.g. by means of ropes, chains, belts or equivalent. The vertical range of movement of the said working platform or equivalent in the elevator shaft is delimited, preferably temporarily, in such manner that movement of the working platform or equivalent can only take place in a section of the elevator shaft, by means of a structure, preferably a beam, which is mounted in the elevator shaft in the path of motion of the said working platform or equivalent, said structure being fitted in the elevator shaft below the said working platform, elevator car or equivalent at a distance from the bottom of the elevator shaft.

In an embodiment of the invention, the aforesaid structure is adapted to stop downward movement of the working platform or equivalent after the latter has hit the said structure.

In an embodiment of the invention, the structure has been arranged to obtain the upward supporting force required for stopping or at least retarding its own motion and/or the motion of the working platform or equivalent hitting the structure from an elevator shaft structure, preferably from the guide rails.

In an embodiment of the invention, the said structure has been arranged to be displaceable vertically relative to the elevator shaft, preferably along the guide rails.

In an embodiment of the invention, the structure comprises means for preventing at least downward motion of the safety structure relative to the elevator shaft.

In an embodiment of the invention, the said means comprise a gripping device arranged to grip the guide rails and fitted to permit upward motion of the structure and to prevent its downward motion.

In an embodiment of the invention, the gripping device has been arranged to be continuously in contact with the guide rail, and when the direction of motion of the gripping device relative to the guide rail is downwards, the gripping device has been arranged to grip the guide rail, preferably by the aid of wedging means.

In an embodiment of the invention, the arrangement comprises two mutually adjacent elevator shafts under construction, each shaft being provided with a working platform or equivalent having a range of movement delimited in such manner that movement of the working platform or equivalent can only take place in a section of the elevator shaft, and that the ranges of movement of the said working platforms or equivalent in the mutually adjacent elevator shafts are located at substantially the same heights.

In an embodiment of the invention, the aforesaid ropes, chains, belts or equivalent are fastened to the aforesaid structure, preferably with a 1:1 or 2:1 ratio.

In an embodiment of the invention, fitted to run in the elevator shaft below the said structure is an elevator car serving elevator users in the lower parts of the building.

In an embodiment of the invention, to stop falling objects, the invention comprises a safety net, plate, grille or equivalent placed in the elevator shaft in the region of said structure, preferably immediately below it, and covering at least part of the cross-section of the elevator shaft.

In an embodiment of the invention, the elevator shaft extending below the said structure is empty. In other words, immediately below the structure 1 there is a substantially empty shaft portion. Without the structure 1 the working platform or equivalent could move to said empty shaft portion.

According to the invention, in a method for elevator construction, to improve safety during construction, the range of movement of a working platform or equivalent displaceable in the elevator shaft is delimited by means of a structure, preferably a beam, mounted in the elevator shaft in the path of the working platform or equivalent so as to permit motion of the platform or equivalent only in a section of the elevator shaft, said structure being fitted in the elevator shaft below the working platform or equivalent at a distance from the bottom of the elevator shaft, said structure being preferably adapted to stop downward motion of the working platform or equivalent after the latter has hit the said structure.

In an embodiment of the invention, the delimited range of movement is shifted upwards by moving the said structure, preferably along the guide rails.

In an embodiment of the invention, the working zone in the other elevator shaft adjacent to the elevator shaft is delimited in such manner that working in each elevator shaft is only allowed in elevator shaft sections located at substantially the same height.

In an embodiment of the invention, fitted to run in the elevator shaft below the said structure is an elevator car serving elevator users in the lower parts of the building during construction work being carried out in the elevator shaft above the structure, and below the said structure there is in the elevator shaft a platform to which the hoisting ropes of the elevator car are secured, and the hoisting height of the elevator car is increased by raising the said platform.

In an embodiment of the invention, the distance between the structure and the said platform is increased by moving the structure upwards in the elevator shaft.

In an embodiment of the invention, the range of movement of the working platform or equivalent in an elevator shaft under construction or in an elevator shaft section under construction is delimited in such manner that the elevator shaft or shaft section under construction comprises a portion where the working platform or equivalent can move and a portion where the working platform or equivalent can not move. Thus, an elevator shaft space/portion under construction where e.g. guide rails are being installed can be divided into parts where the working platform can be moved and a part which can not be reached by the working platform even if this latter part B is included in the shaft section under construction and not in the shaft section already in use serving users of the building.

According to the invention, the safety structure is fitted at a desired height in the elevator shaft so as to delimit the range of movement of the working platform or equivalent and preferably also to stop its motion when the elevator car hits the safety structure. The safety structure comprises means for preventing at least downward motion of the safety structure relative to the elevator shaft.

In an embodiment of the invention, the safety structure comprises at least one stopper element for receiving and preferably absorbing the impact when a moving working platform or equivalent hits the safety structure.

In an embodiment of the invention, the means for preventing the motion of the safety structure relative to the elevator shaft comprise a gripping device adaptable to seize an elongated guide rail, which device permits guide rail movement relative to the gripping device in a first longitudinal direction of the guide rail and prevents guide rail movement relative to the gripping device in a second longitudinal direction of the guide rail, said first and second directions being mutually opposite.

In an embodiment of the invention, the safety structure comprises one or more of the following:
Means for connecting a rope or chain to the safety structure, such as e.g. anchorage means, and one or more pulleys for guiding the rope or chain,
guides fitted to be laterally supported by an elongated guide rail to guide the safety structure in the elevator shaft,
grip releasing means, preferably manual means for moving a brake part pressed against a guide rail from a braking position towards a position of reduced braking force,
a pulley for guiding a speed limiter rope,
means for locking the safety structure to the car guide rails,
a safety net, plate, grille or equivalent designed to stop falling objects and fittable to cover at least part of the cross-section of the elevator shaft.

In an embodiment of the invention, the safety structure is a substantially beam-like structure, preferably fittable between two guide rails and provided with guides at its ends.

### LIST OF FIGURES

In the following, the invention will be described in detail by the aid of embodiment examples by referring to the attached drawings, wherein

FIG. 1 presents a safety structure according to an embodiment of the invention.

FIG. 2 presents a side view of the safety structure in FIG. 1 as seen from lateral direction A.

FIG. 3 presents a detail of the safety structure illustrated in FIGS. 1 and 2 as seen from direction I in separation from other structures.

FIG. 4 presents a detail of the safety structure illustrated in FIGS. 1 and 2 as seen from direction II in separation from other structures.

FIG. 5 presents a diagram representing a construction-time elevator arrangement according to an embodiment of the invention in a building, depicted in side view.

FIG. 6 is a three-dimensional representation of an embodiment of the arrangement of the invention.

FIG. 7 presents an embodiment of the arrangement of the invention in side view.

FIG. 8 is a diagrammatic representation of a construction-time elevator arrangement according to an embodiment of the invention in a building, depicted in side view.

### DETAILED DESCRIPTION OF THE INVENTION

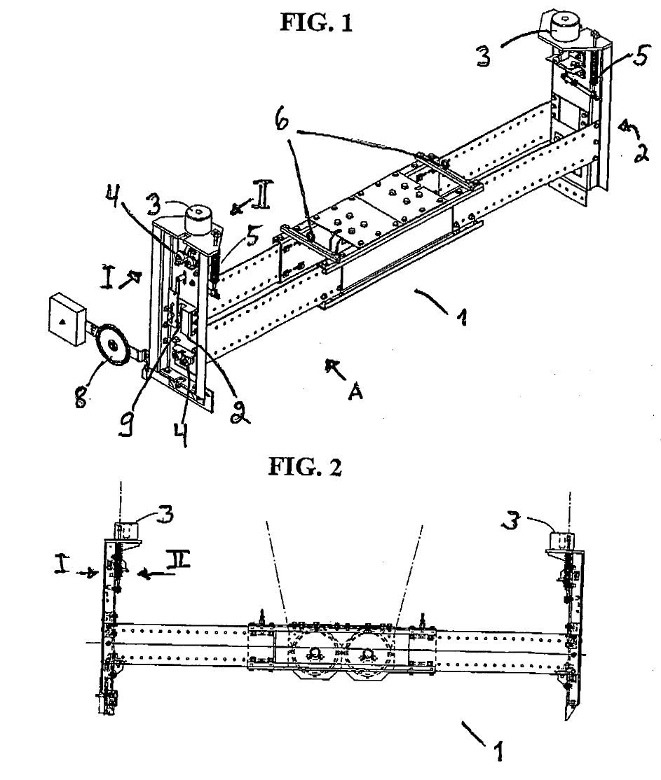

FIG. 1 presents a three-dimensional view of a safety structure according to the invention, designed to be mounted in an elevator shaft. The safety structure 1 comprises means 2 for preventing downward motion of the safety structure 1 relative to the elevator shaft. The safety structure 1 preferably also comprises stopper elements 3 for receiving an impact, which are e.g. normal buffers and preferably capable of absorbing the impact if e.g. a moving elevator car hits the safety structure. The safety structure 1 preferably also comprises means 6 for connecting a rope or chain to the safety structure, such as e.g. anchorage means and/or a pulley for guiding a rope or chain via the safety structure. The safety structure preferably also comprises guides 4, which are designed to be fitted to be pressed against an elongated guide rail to guide the safety structure in the elevator shaft. The safety structure preferably also comprises grip releasing means 5, which are preferably manual means for moving a brake part pressed against a guide rail from the braking position towards a position of reduced braking force. In addition, the safety structure preferably but not necessarily also comprises a pulley 8 for guiding the speed limiter rope.

Not all the features (e.g. items 3,4,5,6,8,9) presented in the figure are necessary for the invention to be functional, nor do they necessarily have to be exactly as described here. The means 2 for preventing at least downward motion of the safety structure 1 relative to the elevator shaft are important for the functionality of the invention. They preferably comprise a normal safety gear as illustrated in FIG. 1, but they could also be implemented differently. The safety gear presented here comprises a roller 9 placed against a guide rail. When the roller is rotated in one direction as a result of motion in contact with the guide rail, it becomes wedged against the guide rail and thus produces a braking action. When moving in the opposite direction, the roller undergoes no wedging and causes no braking. Therefore, the safety structure can e.g. be moved upwards against the guide rail without resistance, whereas downward motion is prevented due to activation of the safety gear 2. It is preferable to set the roller in a position continuously leaning against the guide rail during operation in order that movement of the safety device relative to the guide rail should be transmitted to the safety gear. Alternatively, these means 2 could also be implemented differently. To produce the aforesaid effect, it would be possible to use alternatively e.g. a wedge piece instead of a roller 9. The invention could also be applied using a solution where the said means 2 consist of locking elements, e.g. screw-tightenable clamps, securely but releasably lockable to the guide rail.

In the embodiment presented in FIG. 1, the safety structure 1 is a substantially beam-like structure, but it could also be a different type of structure. Due to the beam-like design, the structure is simple and easy to fit between two guide rails, preferably normal T-shaped car guide rails, preferably so that the guides 4 at its ends, being set against the guide rail, can guide the safety structure I when the latter is being moved in the vertical direction. The safety structure is intended to be mounted in such manner that that the elongated guide rails pass vertically at the ends of the beam structure between the rollers of the guides 4 and simultaneously in the slots of the safety gears 2.

FIG. 2 presents the safety structure of FIG. 1 as seen from direction A. This figure shows diverting pulleys depicted in broken lines to indicate what the safety structure is preferably like when a diverting pulley is to be used in the safety structure, e.g. when the elevator arrangement has a 2:1 hoisting ratio.

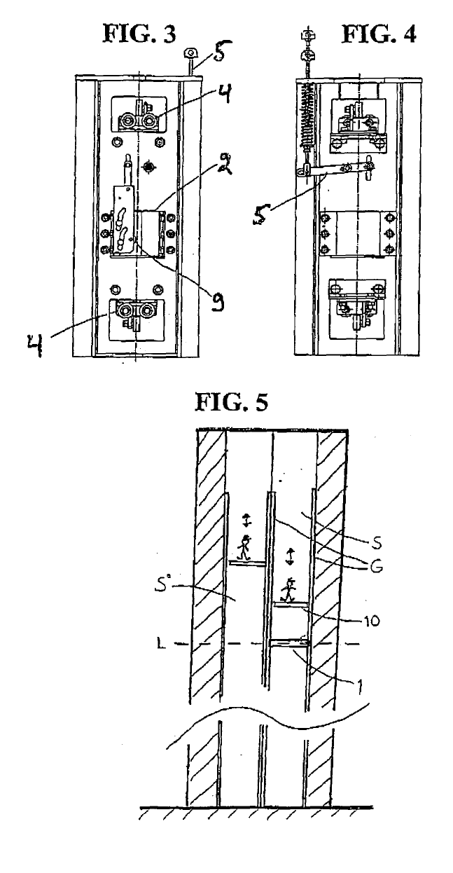

FIG. 3 presents a detail of the safety structure illustrated in FIGS. 1 and 2 as seen from direction I in separation from other structures. FIG. 4 presents the same detail of the safety structure in FIGS. 1 and 2 as seen from direction II in separation from other structures. Grip releasing means 5 (preferably a lever structure actuatable by means of a rope) are integrated with the mounting of the safety gear 2 roller to be fitted to lean against the guide rail. In this way it can be moved from the braking position towards a position of reduced braking force if the grip is to be released.

FIG. 5 presents a diagram representing an elevator arrangement according to an embodiment of the invention, depicted in side view. Movement of the working platform or equivalent 10 is delimited by means of a structure 1 temporarily mounted in the elevator shaft in the path of the working platform or equivalent 10, so that the latter can only move in a certain portion of the elevator shaft S located at a desired height (above level L), which elevator shaft S in its entirety will later form an elevator shaft for actual elevator operation. The structure placed below the working platform at a distance from the bottom of the elevator shaft thus delimits downward motion of the working platform and is preferably adapted to stop the downward movement of the working platform or equivalent after the latter has hit the said structure. In this solution, the range of upward movement of the working platform is not necessarily specifically delimited, but preferably it is delimited as well. This can be advantageously implemented using e.g. a hoisting beam to which the working platform is movably secured. Below the structure 1, the elevator shaft extends downward substantially empty. In other words, immediately below the structure 1 there is an empty shaft portion, The elevator shaft extends downwards preferably empty throughout the whole height of the elevator shaft S, S′ below the structure 1 or, in the case of a jump elevator, the elevator shaft S, S′ continues downwards empty down to the level of the machine room of the jump elevator. Preferably below the structure, in its vicinity, the elevator shaft is void of at least traffic, moving ropes and people. The structure 1 is preferably arranged to obtain the upward supporting force required for stopping or at least retarding its own motion and/or the motion of the working platform or equivalent hitting the structure 1 from an elevator shaft structure, preferably from the guide rails G. As the construction of the elevator shaft advances, the said structure is moved upwards, which is preferably arranged to be implemented using the guide rails to guide the structure.

The structure 1 is preferably of a design described elsewhere in the present application, most preferably of the design explained in the description of FIG. 1. If the structure 1 has been formed to comprise safety-gear type means 2, then it is preferable to fit the safety gear/safety gears against the guide rails G so that they permit upward motion of the structure and prevent its downward motion. The safety gear is preferably arranged to be continuously in contact with the guide rail, preferably via a roller, and when safety gear motion relative to the guide rail takes place in the downward direction, the safety gear has been arranged to grip the rail, preferably by the action of wedging means, which are actuated by the guide rail.

The elevator arrangement in FIG. 5 comprises two mutually adjacent elevator shafts (S and S′) under construction, but the invention is also applicable for use in solutions comprising only one elevator shaft. According to an embodiment of the invention, in multi-shaft elevator solutions the hazard caused by mutually adjacent elevator shafts to each other is minimized by delimiting the working zone in each shaft so that both working zones are located at the same height. In this case, as the work is progressing, the working zones are preferably redefined simultaneously in both elevator shafts and again in such manner that the working zones are located at the same height. One or both of the elevator shafts can be provided with a working platform or equivalent whose range of movement is delimited, preferably by means of the structure 1, so that movement of the platform can only take place in a portion of the elevator shaft as described above. This delimitation can also be implemented by other means, which may be necessary if movable working platforms are not used in one of the shafts.

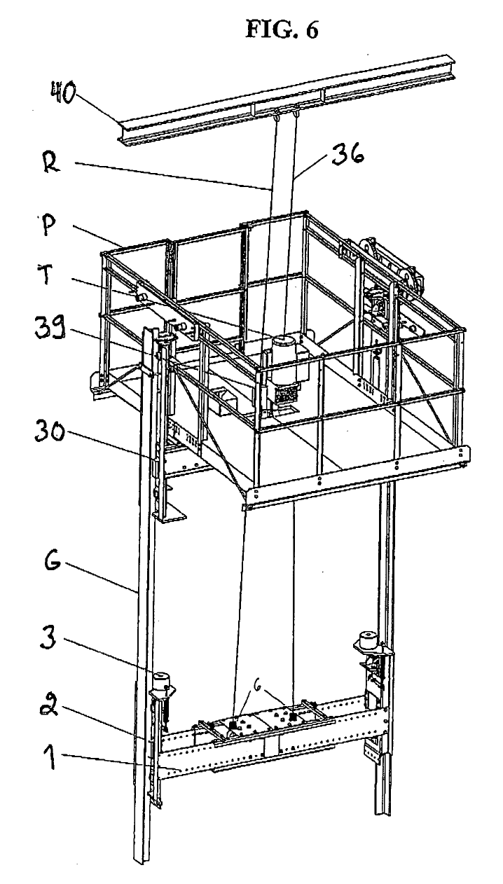

FIG. 6 presents an arrangement implemented with a 1:1 hoisting ratio and utilizing the safety structure 1. A safety rope R and a hoisting rope 36 are fastened by their first ends to a hoisting beam mounted in the elevator shaft and by their second ends to the safety structure 1. The working platform P is moved by means of a hoist T which is mounted on the working platform P and climbs along the rope 36.

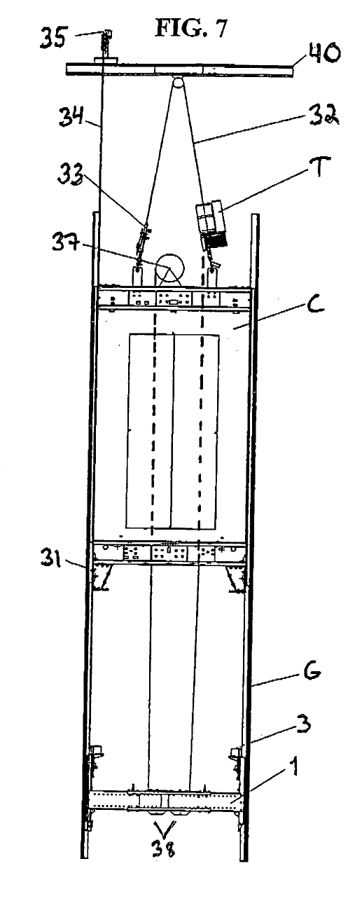

FIG. 7 presents an arrangement implemented in a corresponding manner with a 2:1 hoisting ratio, wherein the movable working platform or equivalent is an elevator car C. The hoist T, preferably a Tirak hoist, drives a rope 32 through itself, the slack rope portion being passed via pulleys 38 mounted on the safety beam 1 to a reel 37 on the top of the elevator car C.

The list below refers to FIGS. 6 and 7:

1 safety structure

2 safety gear of safety structure

3 buffer

30 safety gear of working platform, slack rope operated

31 safety gear of elevator car

32 Tirak rope

33 so-called automatic safety gear trigger

34 speed limiter rope

35 speed limiter

36 rope of hoist, such as Tirak

37 Tirak rope reeler

38 Tirak rope pulley

39 so-called “block stop”

40 hoisting beam

T Tirak

C elevator car

G guide rail

R safety rope

P working platform

The arrangements illustrated in FIGS. 6 and 7 are applicable for utilization in conjunction with the arrangement represented by FIG. 5 and in the method described elsewhere in the present application. In FIGS. 6 and 7, the working platform or equivalent moves along the guide rails G; for the sake of clarity, other structures of the elevator shaft (extending below the structure 1 in the figure) are omitted from the figure. In this solution, the range of movement is delimited at the lower end by the safety structure 1. At the upper end, the range need not necessarily be delimited, but the hoisting beam 40 may function as a delimiter. Also, the user could be alerted when approaching the end of guide rails not yet completed. Not all the features presented in FIGS. 6 and 7 are required for the functionality of the invention, but features can be varied or omitted as necessary by the person skilled in the art. In both FIGS. 6 and 7, the working platform or equivalent (P and C) comprises stopper elements (e.g. buffer), and the buffers 3 comprised in the structure 1 are fitted on the path of the stopper elements. This stopper arrangement is preferably included in all the embodiments described in the present application. However, even without stopper elements, the structure 1 functions as a delimiter of the range of movement, because it gives the user a visual signal about an approaching limit zone.

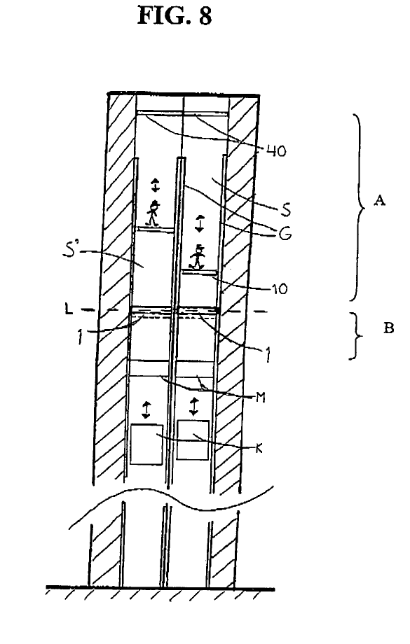

In the embodiments described here, it is possible to fit an elevator car K below the structure 1 for operation during construction of the elevator, e.g. as illustrated in FIG. 8, to serve elevator users in the lower parts of the building. Thus, installers working from a working platform 10 movable in the elevator shaft (S, S′) portion above the structure 1 can carry on the installation of structures, such as e.g. guide rails, in the upper parts of the elevator shaft (S, S′) while the elevator cars K are already in use. In this case, below the structure 1 there is preferably also a platform M supporting the elevator car K, the hoisting ropes (not shown) used to move the elevator car K being secured to this platform. The said platform M is preferably a machine room platform, in which case the platform M also carries a hoisting machine for moving the hoisting ropes. The elevator shaft (S, S′) below the structure 1 extends empty down to the level of the platform M, in practice to the most elevated parts of the structures on the machine room platform, e.g. to the ceiling structure. In other words, below the structure 1 there is an empty portion of the elevator shaft (S, S′). In the manner illustrated in FIG. 8, the structure 1 can be installed at a distance from the structures on platform M. Without the structure 1, platform (10,P,C) could move downwards past level L if there are no obstructions in the path of the platform. The distance between the structure 1 and the platform X increases when the structure 1 is moved upwards while the platform supporting the elevator car K remains in place and the elevator car K continues serving users in the lower parts of the building. When sufficient progress has been made in the construction work in the upper parts, a jump-lift can be carried out and platform M is also moved upwards. In the figure, reference number A indicates that portion of the elevator shaft section under construction in the upper part of the building where the working platform is allowed to move, and reference number B indicates that portion of the elevator shaft section under construction in the upper part of the building which can not be reached by the working platform. A and B together form the elevator shaft section under construction.

The elevator arrangement preferably but not necessarily comprises a safety net, plate, grille or equivalent placed in the elevator shaft (S, S′) in the region of the structure 1, preferably immediately below it, and covering at least part of the cross-section of the elevator shaft to stop falling objects. The net, plate, grille or equivalent may be secured to the structure 1 and/or to the elevator shaft, and, alone or together with the safety structure 1, it covers substantially the entire consumption of the elevator shaft. In FIG. 8, the net is depicted with broken line below the structure 1. The structure 1 is preferably of simple and light construction and easy to move. Therefore it is most preferably mounted in separation from the hoisting machine.

In the method of the invention in elevator construction, to improve safety, during construction, the range of movement of the working platform or equivalent movable in the elevator shaft is delimited in such manner that movement of the working platform or equivalent can only take place in a section of the elevator shaft, which elevator shaft in its entirety will later form an elevator shaft intended for actual elevator operation. This is advantageously accomplished by means of a structure, preferably a beam-like structure placed between the guide rails, which structure is fitted in the elevator shaft below the said working platform, elevator car or equivalent at a distance from the bottom end of the elevator shaft, said structure being fitted to stop downward motion of the working platform, elevator car or equivalent after the latter has hit the said structure.

In the method, as the work progresses, the delimited range of movement is shifted upwards by removing the said structure 1, preferably along the guide rails. Such removal of the structure 1 is preferably implemented by raising the hoisting beam 40 e.g. by means of a hoist, said beam being connected to the structure 1 by ropes.

In the method, if there is beside the elevator shaft S a second corresponding elevator shaft S′, the working zone in this second elevator shaft can preferably also be delimited in such manner that in each shaft working is only permitted in elevator shaft sections located at substantially the same heights.

In other respects, the procedures observed in the method of the invention may be as described before. It is preferable to use a safety structure as presented earlier in the description relating to FIG. 1.

All the solutions described in the present application are applicable for use in elevator construction, which refers to e.g. initial installation, repair or modification of an elevator. The solutions are particularly well suited for so-called jump elevators and in the construction of high-rise elevators.

Especially in the case of a jump elevator, the method comprises an elevator car K fitted to travel in the elevator shaft (S, S′) below the structure 1 in the manner illustrated in FIG. 8 to serve elevator users in the lower parts of the building during installation work being carried out in the elevator shaft (S, S′) above the structure 1. Below the structure 1 there is in the elevator shaft (S, S′) a platform M to which the hoisting ropes of the elevator car are secured. In the method, the hoisting height of the elevator car K is increased by raising the platform M.

In the method, as installation work is progressing in the parts above the platform M, the range of movement of the working platform (10,P,C) can be shifted upwards to increase the distance between the structure 1 and the platform M.

It is obvious to a person skilled in the art that different embodiments of the invention are not exclusively limited to the embodiments described above, in which the invention has been described by way of example, but that many variations and different embodiments of the invention are possible within the scope of the inventive idea defined in the claims below.

1. An elevator arrangement, comprising:
at least one elevator shaft;
a working platform arranged to be movable in the elevator shaft, shaft; and
a power source for moving the working platform means of ropes, chains or belts,
wherein the vertical range of movement of the working platform in the elevator shaft has been delimited, in such manner that movement of the working platform can only take place in a section of the elevator shaft, by means of a structure mounted in the elevator shalt in the path of motion of the working platform, the structure having been fitted in the elevator shaft below the working platform at a distance from a bottom of the elevator shaft.

2. The elevator arrangement according to claim 1, wherein the structure has been adapted to stop downward movement of the working platform after the working platform has hit the structure.

3. The elevator arrangement according to claim 1, wherein the structure has been arranged to obtain the upward supporting force required for stopping or at least retarding its own motion and/or the motion of the working platform hitting the structure from an elevator shaft structure.

4. The elevator arrangement according to claim 1, wherein the structure has been arranged to be displaceable vertically relative to the elevator shaft.

5. The elevator arrangement according to claim 1, wherein the structure comprises means for preventing at least downward motion of the safety structure relative to the elevator shaft.

6. The elevator arrangement according to claim 5, wherein the means for prevention at least downward motion of the safety structure relative to the elevator shaft comprise a gripping device arranged to grip the guide rails and fitted to permit upward motion and prevent downward motion of the structure.

7. The elevator arrangement according to claim 6, wherein the gripping device has been arranged to be continuously in contact with the guide rail, and when the direction of motion of the gripping device relative to the guide rail is downwards, the gripping device has been arranged to grip the guide rail.

8. The elevator arrangement according to claim 1, wherein the arrangement further comprises two mutually adjacent elevator shafts under construction, each shaft being provided with a working platform having a range of movement delimited in such manner that movement of the working platform can only take place in a section of the elevator shaft, and that the ranges of movement of the working platforms in the mutually adjacent elevator shafts are located at substantially the same heights.

9. The elevator arrangement according to claim 1, wherein the ropes, chains or belts are secured to the aforesaid structure with a 1:1 or 2:1 ratio.

10. The elevator arrangement according to claim 1, wherein an elevator car serving elevator users in the lower parts of the building has been fitted to run in the elevator shaft below the structure.

11. The elevator arrangement according to claim 1, wherein to stop falling objects, the elevator arrangement further comprises a safety net, plate or grille placed in the elevator shaft in the region of said structure, and covering at least part of the cross-section of the elevator shaft.

12. The elevator arrangement according to claim 1, wherein the elevator shaft extends empty below the structure.

13. A method in elevator construction to improve safety during construction, said method comprising the steps of:
delimiting the range of movement of a working platform displaceable in an elevator shaft by means of a structure mounted in the elevator shaft in the path of motion of the working platform;
fitting the structure is in the elevator shaft below the working platform at a distance from the bottom of the elevator shaft, said structure being adapted to stop downward motion of the working platform after the the working platform has hit the structure.

14. The method according to claim 13, further comprising the step of shifting the delimited range of movement upwards by moving the structure along the guide rails.

15. The method according to claim 13, further comprising the step of delimiting a working zone in a second elevator shaft adjacent to the elevator shaft in such manner that in each elevator shaft working is only allowed in elevator shaft sections located at substantially the same heights.

16. The method according to claim 13, further comprising the step of fitting an elevator car to run in the elevator shaft below the structure to serve elevator users in the lower parts of the building during construction work being carried out in the elevator shaft above the structure, and that below the said structure there is in the elevator shaft a platform to which the hoisting ropes of the elevator car are secured, and that the hoisting height of the elevator car is increased by raising the platform.

17. The method according to claim 13, further comprising the step of increasing, the distance between the structure, and the platform by moving the structure upwards in the elevator shaft.

18. The method according to claim 13, further comprising the step of delimiting the range of movement of the working platform in the elevator shaft under construction or in a section under construction of the elevator shaft in such manner that the elevator shaft under construction or the section under construction of the elevator shaft comprises a portion where the working platform is allowed to move and a portion where the working platform is not allowed to move.

19. A safety structure designed to be fitted at a desired height in an elevator shaft for delimiting the range of movement of a working platform in the elevator shaft and for stopping motion of the working platform when an elevator car hits the safety structure, wherein the safety structure comprises a device configured to prevent at least downward motion of the safety structure relative to the elevator shaft.

20. The safety structure according to claim 19, wherein the device comprises at least one stopper element for receiving and absorbing the impact when a moving working platform hits the safety structure.

21. The safety structure according to claim 19, wherein the device that prevents the motion of the safety structure relative to the elevator shaft comprises a gripping device adaptable to seize an elongated guide rail, the gripping device permitting guide rail movement relative to the gripping device in a first longitudinal direction of the guide rail and preventing guide rail movement relative to the gripping device in a second longitudinal direction of the guide rail, said first and second directions being mutually opposite.

22. A safety structure according to claim 19, further comprising one or more of the following:
means for connecting a rope or chain to the safety structure;
guides fitted to be laterally supported by an elongated guide rail to guide the safety structure in the elevator shaft;
grip releasing means;
a pulley for guiding a speed limiter rope;
means for locking the safety structure to the car guide rails; and
a safety net, plate or grille designed to stop falling objects and fittable to cover at least part of the cross-section of the elevator shaft.

23. The safety structure according to claim 19, wherein the safety structure is a substantially beam-like structure, fittable between two guide rails and comprising guides at ends thereof.

24. A method in elevator construction, comprising the step of:
delimiting the range of movement of the working platform in the elevator shaft under construction or in a section under construction of the elevator shaft in such manner that the elevator shaft under construction or the section under construction of the elevator shaft comprises a portion where the working platform is allowed to move and a portion where the working platform is not allowed to move.

25. The method according to claim 24, wherein the range of movement of the working platform is delimited with a safety structure, the safety structure designed to be fitted at a desired height in an elevator shaft for delimiting the range of movement of a working platform in the elevator shaft and for stopping motion of the working platform when an elevator car hits the safety structure, wherein the safety structure comprises a device configured to prevent at least downward motion of the safety structure relative to the elevator shaft.

26. The method according to claim 24, wherein the elevator is an elevator arrangement, comprising:
at least one elevator shaft;
a working platform arranged to be movable in the elevator shaft; and
a power source for moving the working platform by means of ropes, chains or belts,
wherein, the vertical range of movement of the working platform in the elevator shaft has been delimited, in such manner that movement of the working platform can only take place in a section of the elevator shaft, by means of a structure mounted in the elevator shaft in the path of motion of the working platform, the structure having been fitted in the elevator shaft below the working platform at a distance from a bottom of the elevator shaft.
